(19) United States
(12) Patent Application Publication
(10) Pub. No.: US 2006/0059016 A1
(43) Pub. Date: Mar. 16, 2006

(54) Verifying personal authority without requiring unique personal identification

(76) Inventor: John W. Ogilvie, Salt Lake City, UT (US)

Correspondence Address: OGILVIE LAW FIRM, 1320 EAST LAIRD AVENUE, SALT LAKE CITY, UT, 84105, US

(21) Appl. No.: 11/203,732

(22) Filed: Aug. 15, 2005

Related U.S. Application Data
(60) Provisional application No. 60/609,019, filed on Sep. 10, 2004.

(51) Int. Cl. G06Q 10/00

(52) U.S. Cl. 705/2

(57) ABSTRACT

Methods and systems are disclosed for managing confidential information (116). In some cases, a group characteristic description (512) is submitted (304), in conjunction with the submission (306) of confidential information, for storage in an electronic repository (510). A code (522) is supplied (308) in response. The electronic repository is free of data (114) that specifically identifies the person (502) to whom the confidential information pertains. The code may be subsequently entered (402), and verification procedures then use the code and information about group characteristics to determine whether to retrieve (410) the confidential information. Thus, the authority of a person to retrieve or otherwise claim confidential information can be determined without use of a name, address, or other information (114) identifying the person to whom the confidential information pertains.

### RELATED APPLICATIONS

The present application claims priority to, and incorporates by reference, U.S. provisional patent application Ser. No. 60/609,019 filed Sep. 10, 2004.

### BACKGROUND

Published United States Patent Application Publication No. US2005/0059034 A1 discusses methods and kits for conducting anonymous genetic testing. As noted in the Abstract of the publication, a patient is provided with an Alias ID and Password. The Alias ID is used to track a genetic sample from the patient. Both the Alias ID and Password are then used by the patient to obtain the results of the genetic test. The publication also states that a patient may choose to provide personal information, such as their name and address, to the test provider, and that a patient may choose to allow chosen outside third parties, such as a family member or physician, to access their information; see, e.g., paragraphs 31 through 33. Other aspects of the publication may also be of interest, and this brief introduction to the publication is not meant to be a complete summary or a substitute for reading the publication itself.

But even if technology described in this publication were used to allow a patient to have a genetic test performed while remaining anonymous, as stated in the publication, problems not adequately addressed in the publication are possible. For instance, persons may falsely represent themselves as legitimate holders of Passwords, and hence as the persons to which the genetic test results pertain, even though the results pertain to someone else because they are based on someone else's genetic sample. This may be done by using Passwords that have been stolen, sold, or otherwise improperly obtained. If the patient's personal identification, such as name and address, is linked in the publication's system to the test results, then there may be little or no risk that the test results for one person can be misrepresented as belonging to another person. But there would also be no anonymity of test results, with respect to anyone who used the patient's personal information in the system to verify that the test results pertain to that patient.

### BRIEF SUMMARY OF THE INVENTION

The present invention provides tools and techniques which can help manage electronically stored confidential information. Some embodiments store and retrieve confidential information about a particular person without specifically identifying that person, even when one has full access to a database containing their confidential information, for example.

Some methods of the invention for submitting confidential information include the steps of: submitting a group characteristic description for storage in an electronic repository, the group characteristic description describing a characteristic of a person which is shared by at least a dozen other people, the electronic repository being free of data fields that identify the person by name, telephone number, residential address, employer, credit card number, insurer-issued identification number, or government-issued identification number; and submitting confidential information for retrievable storage in the electronic repository in connection with the group characteristic description, the confidential information pertaining to the person; thereby submitting for later retrieval the confidential information of the person, without storing the person's identification in connection with their confidential information, and nonetheless facilitating verification that the confidential information pertains to the person.

Some methods of the invention for retrieving confidential information include the steps of: entering a code into an interface of an electronic repository which contains confidential information pertaining to a person, the electronic repository being free of data fields that identify the person by name, telephone number, residential address, employer, credit card number, insurer-issued identification number, or government-issued identification number; and using a verification procedure based on the group characteristic description and the code to at least help in verifying that a person to whom the confidential information may pertain is indeed the person to which it does pertain.

Some systems of the invention for managing confidential information include: an electronic repository which contains confidential information pertaining to a person and is configured for retrieval of the confidential information by the person in response to at least entry of a code, the electronic repository being free of data fields that identify the person by name, telephone number, residential address, employer, credit card number, insurer-issued identification number, or government-issued identification number, the electronic repository also containing a group characteristic description which places the person in a group of hundreds of people having a shared characteristic without specifically identifying the person; and a processor and a memory configured to provide an interface to the electronic repository supporting a verification procedure based on the group characteristic description and the code.

Some embodiments of the invention include methods and/or means for providing anonymous test results. Some embodiments of the invention include methods and/or means for managing anonymous medical information. However, although many examples given herein involve confidential medical information, embodiments of the invention may also be used to manage other types of confidential information. Different embodiments and uses of the invention may serve different goals for different people, so this summary is provided to help illustrate the invention, not as a replacement for the claims that define the invention. The present invention is defined by the claims, and to the extent this summary conflicts with the claims, the claims should prevail.

### BRIEF DESCRIPTION OF THE DRAWINGS

To illustrate the manner in which the advantages and features of the invention are obtained, a more particular description of the invention will be given with reference to the attached drawings. These drawings only illustrate selected aspects of the invention and thus do not fully determine the invention's scope. In the drawings:

FIG. 1 shows a prior approach in which a person's confidential information (such as medical test results) is linked to their personal unique identifying information (such as their name and address) in a single database.

FIG. 2 shows a prior approach in which a person's confidential information is linked to their personal identifying information by way of a correlation between two databases.

FIG. 3 is a flowchart illustrating methods of the present invention for submitting confidential information to be stored electronically.

FIG. 4 is a flowchart illustrating methods of the present invention for retrieving electronically stored confidential information.

FIG. 5 is a diagram illustrating systems of the present invention for storing, retrieving, sharing, and otherwise managing confidential information.

### DETAILED DESCRIPTION

In describing the invention, the meaning of several important terms is clarified, so the claims must be read with careful attention to these clarifications. Specific examples are given to illustrate aspects of the invention, but those are not necessarily required aspects or the only permissible aspects. People of skill in the art(s) relevant to a given claim will understand that other examples may also fall within the meaning of the terms used, and hence within the scope of the claim. Important terms may be defined, either explicitly or implicitly, here in the Detailed Description and/or elsewhere in the application file.

### Some Examples of Need for the Invention

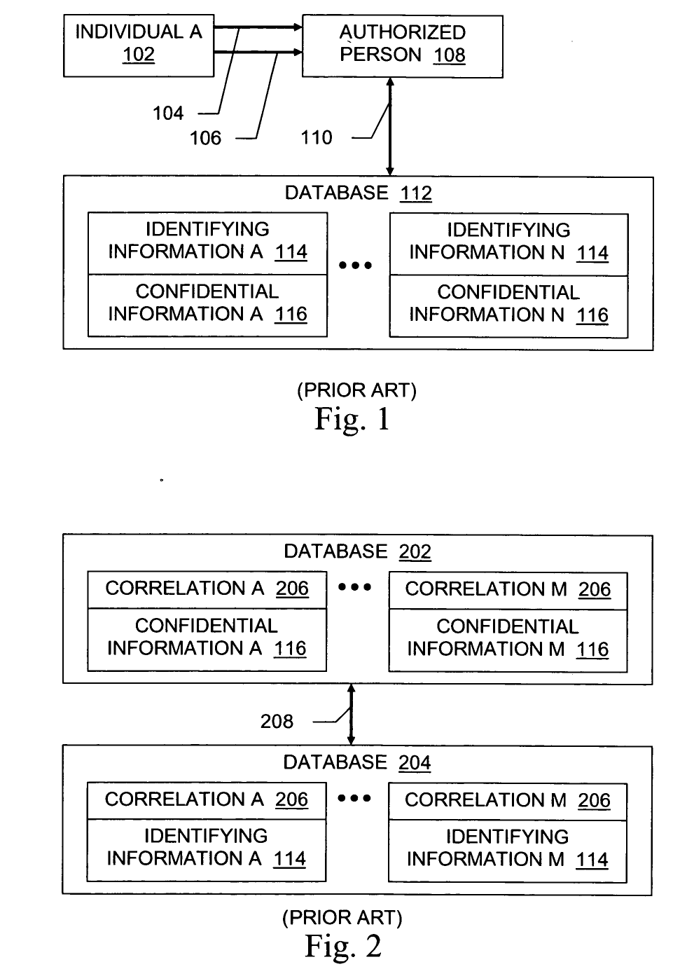

With reference to FIGS. 1 and 2, it is well known that employers, religious institutions, educational institutions, clubs, health service providers, insurance companies, government agencies, and other entities routinely have access, through authorized personnel 108, to personal information 116 of private individuals 102. Such confidential information 116 includes the results of tests, background checks, and other investigations performed, for instance. However, the databases 112, 202, 204 that these entities use generally contain personal identifying information 114 which allows one to locate the identified person 102 or to otherwise tie the confidential information 116 to them in their absence and without requiring (at least technologically, as opposed to legally) any active consent from them. Electronically stored personal identifying information 114 may include data fields such as a person's name (family and individual), residential address, photographic likeness, DNA print, fingerprint, a government ID number such as driver license number, passport number, or social security number, and so on. Such databases 112, 202, 204 are not generally accessible to third parties who met the person 102 socially, for instance, and who want to know the person's status before deciding whether to interact with the person in a way that could put their own health, reputation, or assets at serious risk.

Of course, one can simply ask another person to disclose their status and history. But even if the person appears to comply, one may be left with substantial questions about the accuracy and completeness of their answer. These questions might be put to rest, or at least reduced, by credible access to a database containing pertinent personal status or personal history information. However, access 110 to such databases is typically restricted to health professionals, court personnel, bank personnel, government officials, or similar authorized persons 108.

Moreover, because many databases link financially sensitive, embarrassing, or otherwise potentially damaging personal information 116 to information 114 uniquely identifying the person 102 in question, and because it is suspected or known that such linkage is common, much personal information is kept out of databases by people who fear (sometimes quite correctly) that it will be disclosed and harm them. Even if the person 102 trusts that access to the database 112 will be limited, the person 102 may reasonably resist providing 104 confidential information and also providing 106 personal identifying information to the same authority 108. Thus, people 102 may be willing to provide confidential information when their identity is kept completely secret, and they may be willing to provide identity information when their confidential information is not also provided, but they may refuse to provide both their identity and their secrets to the same authority 108 or the same database 112.

In short, databases of personal information create both a risk of over-disclosure and a risk of under-disclosure, by linking confidential personal information to personal identifying information. This may be a direct linkage, as in FIG. 1, in that the identifying information 114 and the confidential information 116 are stored in a single database 112; indeed, they may be stored in the same data record. Linkage may also be indirect, as illustrated in FIG. 2, in that two databases 202 and 204 are present, and connecting 208 the identifying information 114 to the confidential information 116 requires both (a) knowledge of some correlating number or code, and (b) access to both databases. However, one may well ask how personal information can be properly entered, updated, corrected, referenced, deleted, and otherwise used if the identity of the person to whom it pertains is not in the database 112, or else in some correlated databases 202, 204. The present invention may be helpful in this regard.

Confidential information in general may pertain most closely to some inanimate item, such as a secret industrial process for manufacturing pharmaceuticals or unpublished industrial computer program source code for an operating system, or it may pertain to individuals. The former type of industrial confidential information does not generally pertain to a person, but it may if that person has some significant or unusual role with respect to it, e.g., if the person is the information's primary caretaker, creator, inventor, author, etc. Other types of confidential information always pertain to some person. For instance, medical testing can provide important and trustworthy information 116 about a person's medical status, including without limitation information 116 about genetic predispositions to disease, other conditions detectable through genetic testing, fertility, sexually transmitted diseases (a.k.a. STDs, sexually transmitted infections, STIs), and other contagious diseases such as tuberculosis. Although the present invention may be used with various types of confidential information 1116, not merely medical information, it is presently expected that protecting electronically stored information pertaining to the medical status of individuals will be a particularly important use of the invention.

Medical information and other information 116 pertaining to an individual can be highly personal. For instance, the knowledge (or even the suspicion) that a person has a given medical condition can expose that person to shame, job loss, emotional trauma, social stigmatization, divorce, and other painful events. Similar concerns can apply to other types of individual confidential information 116, such as intelligence test results, criminal history, ethnicity, ownership of firearms, sexual history, sexual preferences, sexual orientation, religion, marital history, financial history or assets, mental health treatments, political views and activities, employment plans, and travel history, for example.

Not surprisingly, people may be reluctant to share such information about themselves. They may also be very reluctant to trust purported information of this type which is provided directly to them by another person whose status they doubt. If person A tells person B they've never had a sexually transmitted disease, or never been pregnant, or never gotten anyone pregnant, to give just a few examples, then person B may well want some kind of evidence from a third party, e.g., medical test results or records. More generally, sharing confidential information with another person in a credible way can be particularly problematic when that other person has made, or may shortly make, a personal decision based on the purported status of the person to whom the confidential information 116 pertains, e.g., a decision whether to start or continue dating, whether to have sex, whether to marry, whether to have children, whether to divorce, whether to express a controversial opinion or preference, whether to disclose a controversial event in their own life, whether to share medical or intelligence tests, and so on.

As another example, consider the problems involved in determining whether a potential sex partner has HIV/AIDs. The person may not have been medically tested, because doing so involves providing one's name and contact information, which is then linked in a database to the test result. Unauthorized access to the database could result in people other than healthcare professionals learning that so-and-so has HIV/AIDs, which could lead in turn to embarrassment, stressed or broken personal relationships, financial damage, and other harm. Even if the person was tested, however, how is that information to be disclosed in a convenient and credible way to their potential partner? Papers may be easily altered or forged, and a face-to-face visit with the doctor, even if consented to by the tested patient and not too costly, may be inconvenient or even impossible due to limitations on travel and business hours.

Similar problems of incomplete access and/or over-disclosure may also arise with other types of personal information 116. They may arise, for instance, in contexts in which anonymous testing is desired, whether it be for STDs, mental health, intelligence, or other characteristics. They may arise in contexts in which someone's particular aspect or feature is important and relevant, and other aspects, such as the person's identity, gender, ethnicity, or personal history, is irrelevant or even potentially prejudicial. Society has not necessarily even recognized these risks, much less provided ways to reduce or eliminate them without foreclosing opportunities and transactions that could occur with more focused access.

In short, it would be helpful to have tools and techniques which would allow a person A to share with a person B confidential information 116 that pertains to A, and to do so in a manner which permits (or even requires) B to conclude that the information does in fact pertain to A, and to do so without linking the confidential information 116 in a database to information 114 that uniquely identifies A through A's name, address, social security number, insurance number, or the like. Likewise, it would be helpful to associate electronically stored confidential information about a particular person to that person without thereby identifying that person even when one has full access to the database containing the confidential information. The present invention seeks to provide such tools and techniques.

### Some Examples of Use of the Invention

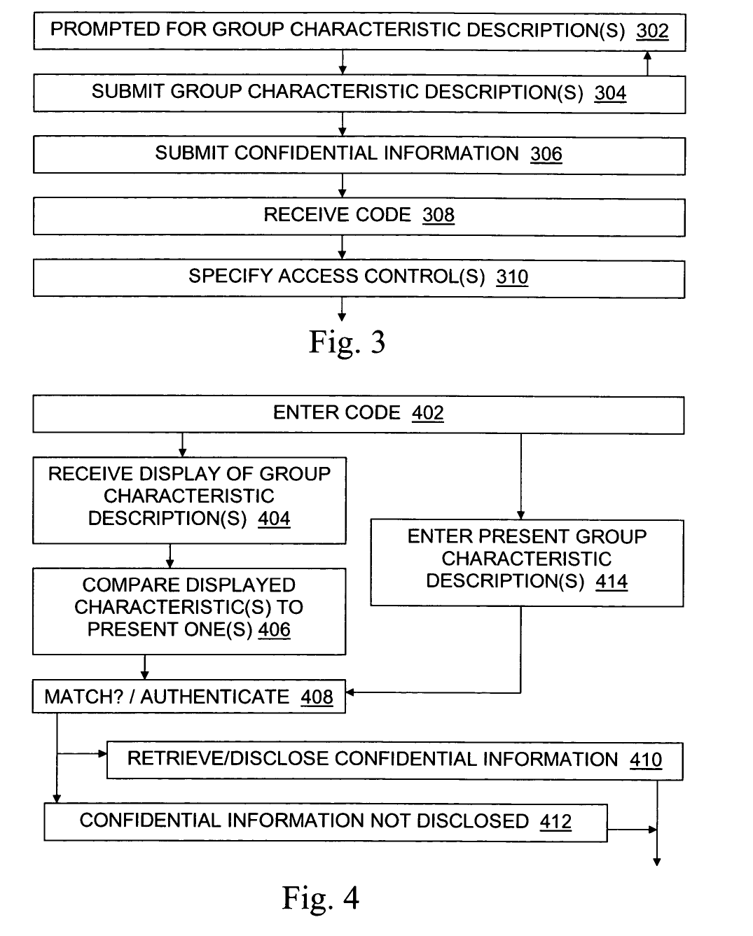

The need for anonymous testing arises in many contexts. Some situations recited in the above-identified published patent application 2005/0059034 include wellness tests, race/ancestry tests, paternity tests, customized drug matching tests, and customized vitamin tests. Other situations in which anonymous medical testing could be beneficial also exist. With reference to FIGS. 3 through 5, for instance, suppose two adults meet, either in person or through a communication medium such as e-mail, chat room, telephone, online dating service, or the like. Assume one person 502 wishes to share with the other person 504 the result 116 of a medical test, either already taken or soon to be taken, to move their relationship forward. The relationship could be casual or serious; the step to be taken based on the medical test results could be consensual sex or something less intimate. The person who was tested, or who shortly will be tested, is called the “tested person”. If each person wishes to share such information with the other, each plays in turn the role of tested person.

The tested person is tested by a licensed and otherwise authorized medical service provider 506. With some embodiments of the present invention, the provider does not need to know the tested person's personal identifying information 114. The code(s) will be used to access the test results, as described below. In one embodiment, the tested person receives from the tester a code 522 which is printed on a piece of paper and also stored in an electronic repository 510. In another embodiment the tested person receives from the tester a code printed on a badge 526 linked to the tested person, and/or a code printed on the tested person's skin. In another embodiment the tested person receives multiple codes 522 from the tester, on paper and physically attached to the tested person. In another embodiment the code is magnetically, electronically, optically, or otherwise recorded on a token, chip, badge, card, or other physical item, and is not necessarily legible to a human reader, as opposed to a magnetic, optical, etc. reader.

The medical service provider performs the test, logs into a database program or similar interface 508, is authenticated, and enters information. In some embodiments, personal identifying information 114 about the tested person is not entered by the medical service provider—only test results 116 are entered, keyed to the code(s) 522 given to the tested person. In some embodiments, general information 512 which does not uniquely identify the person by allowing one to locate them in the general population, is also entered and associated with the test results. The general information 512 may describe one or more physical characteristics of the tested person and/or one or more general characteristics of the test such as the test date and general test location (e.g., city and state or province).

Embodiments in which the tested person provides no personal identifying information to the tester and the tester puts no personal identifying information of the tested person into the database (or into any other data source linked or correlated 206 with the results database) serve to protect the privacy of tested persons 502 and of those 504 whom they choose to take into their confidence. Information 114 that is never entered in a database cannot be erroneously or maliciously released from the database. In such embodiments, the tested person 502 need not trust the medical service provider 506 to keep confidential the tested person's identifying information 114, because the medical service provider is not given that information 114. Neither the tested person 502 nor the medical service provider 506 need to trust the database system 510 and its personnel and access procedures, because the database does not contain—and is not otherwise correlated with—the personal identifying information 114 of tested persons.

However, the test results can be verified as pertaining to the tested person by a third party 504 who is making a personal health decision, with the tested person's cooperation, based on purported test results. This verification may be made with varying degrees of confidence, depending in part on the embodiment. A third party would not be able to find the specific tested person 502 in a general population by using only the database 510 contents. But the third party can verify, at least, that a person who wrongly says “these are my test results” can indeed be ruled out as the actual tested person in many cases. The third party may also be able to confirm that a person is in fact the tested person, in some cases and with some embodiments. This is done by comparing one or more characteristics 512 of the person who claims the test result 116 as their own with the characteristic(s) associated with the test result in the database 510. Those characteristics 512 are not personal identifying information 114, but they do divide the tested population into smaller groups, e.g., according to gender, race, age, and the like.

To further illustrate the invention, some additional examples are now provided. These examples also concentrate on medical information, but it will be understood that other types of confidential information 116 can be similarly submitted, retrieved, shared, and otherwise managed with the present invention. Note also that these examples are numbered from one upward, even though they are not the first examples given in this document. They were numbered thus in the underlying provisional application, and retaining that numbering is convenient, and also deemed less likely to cause confusion than changing it.

### EXAMPLE ONE

Person A 502 is tested for an STD by a medical service provider who receives none of A's personal identifying information 114 but notes A's gender and approximate age. A receives the result 116 and authorizes its entry into the database 510, together with A's gender, A's approximate age, the date of the test, and the city in which the test occurred. A leaves after seeing the result 116 and the other information 512 entered; A is given a checksum code 522 confirming the database entry.

A then offers to disclose the test result to B 504. A gives B the checksum code. B goes to a web site 508, and enters 402 the checksum code 522. The database 510 interface reached through the web site verifies that the checksum is a valid code by computing the check digit and finding it in the checksum code at the correct location. Then the database interface 520 uses the checksum code, or a portion of it, as an index 520 to retrieve 410 a record, which it displays 406 back to B. The record does not contain any personal identifying information 114 of A. It does contain A's gender, A's approximate age, the date of the test, the city in which the test occurred, and the test result, all of which it displays (both descriptions 512 and results 116). Familiar web protocols, such as HTTP and HTTPS, can be used in such networked 518 embodiments.

B cannot be certain of A's medical status at this point, but B is nonetheless closer to certainty about that status than without the properly operated invention. For instance, if any of the displayed items do not match 408 the information A gave B, or the obvious physical characteristics of A as observed by B, then B would know that A was attempting to falsely claim the benefit of someone else's test result. It is possible that A bribed or forced the medical service provider 506 to enter 306 a false result. However, appropriate physical security measures, checks for provider corruption, and legal measures can reduce the likelihood of this possibility.

It is also possible that A bribed or forced someone who has the same gender and age as A to take the test as a surrogate for A. However, random selection 302 during the entry process of the physical characteristics to enter, and entry of several different characteristics rather than just one or two, can reduce the likelihood of this possibility. Thus, if A chose a surrogate having the same gender and age as A, expecting those to be the recorded physical characteristics 512, but different characteristics are chosen instead (unbeknownst to the surrogate or to A—their entry is not observed by either), such as hair color, eye color, and left-handedness, then an attempt to misrepresent the surrogate's test result as A's result is unlikely to succeed.

### EXAMPLE TWO

Person A is tested for an STD by a medical service provider who receives none of A's personal identifying information but mentally notes A's gender, age range of 30-40 years, and Caucasian appearance. A receives the result and authorizes its entry into the database. A leaves after seeing the result entered, with a code confirming the database entry. The medical service provider then enters A's gender, age range of 30-40, and Caucasian appearance as physical characteristics to be associated with A's test result. The choice of characteristics to record could be prompted by the database interface 508 (which could select them randomly), or it could be made by the medical service provider without guidance from the database interface.

A offers to disclose the test result to B. A gives B the code. B dials a toll-free phone number, enters the code 522. The database interface uses the code as an index to retrieve 410 a record, whose content it then provides 410 to B using speech synthesis technology. The record does not contain any personal identifying information 114 of A. The interface does recite A's gender 512, age range of 30-40 (another description 512), and Caucasian appearance 512, and the test result 116.

### EXAMPLE THREE

As in Example Two, but B calls a toll number and thus pays a fee to obtain 410 the result of A's test.

### EXAMPLE FOUR

As in any of the other examples, but A receives different tests (e.g., verifying a vasectomy, genetic test, multiple STD tests) and the interface provides multiple test results 116. A history 116 of a single test (e.g., for HIV) or of multiple tests given at different times could also be provided.

### EXAMPLE FIVE

As in any of the other examples, but none of A's pre-existing physical characteristics are entered in the database. Instead, the code is printed on a badge 526 that is physically linked to A—any attempt to alter the code on the badge or to transfer the badge from A to someone else will be obvious to B from looking at the badge. The code 522 could also be printed directly on A's skin, e.g., on A's thigh or another unobtrusive location. Then A gives the code to B by showing B the printed area of A's skin.

### EXAMPLE SIX

As in Example Five, but the skin-printed code 522 or badge-printed code 522 is combined with a random recording of A's physical characteristics 512, as in Example Two. This gives B even more confidence that the results are from a test taken by A, not by someone else. In another variation, the physical characteristics 512 are not selected randomly.

### EXAMPLE SEVEN

As in the other examples, but A has the option 310 of deleting the record 116, 512 after it is accessed 410, of limiting 310 the number of accesses, and/or logging 310 the number of accesses or access times and dates.

### EXAMPLE EIGHT

As in the other examples, but A's personal identification information 114 is known to the medical service provider, although it is not entered in the inventive database 510 by the medical service provider or by anyone else. For instance, the medical service provider might be A's personal physician, or a clinic worker in a free clinic, who provides other medical services in addition to the testing service, and through that other activity already knows A's identity.

### EXAMPLE NINE

As in the other examples, but A's personal identification information is stored in the database in a secure manner, or in a correlated database in a secure manner, although it is NOT disclosed by way of the invention when test results are disclosed. This example is included for completeness; it is not presently preferred. But it might be acceptable to people 502 if, for instance, their personal identifying information 114 was submitted in an encrypted form and stored in encrypted form and if they correctly had confidence that only they could decrypt it. That is, the personal identification information is stored but effectively unretrievable by third parties and hence does not effectively identify the person.

### EXAMPLE TEN

As in the other examples, but A receives the test result 116 after leaving the medical testing facility, e.g., by entering the code at a web site and receiving the results online, or by calling a toll-free number and entering the code.

More about Methods of the Invention

With particular attention to FIG. 3, but reference to all Figures, the invention provides methods for submitting confidential information. During an optional prompting step 302, the person interacting with a system of the invention is prompted by the system to enter one or more group characteristic descriptions. These descriptions 512 should accurately reflect the person 502 to whom the confidential information being submitted pertains. The system software 520 may prompt for the same characteristic(s) each time, or it may prompt for different characteristic(s) in a random manner. It may also record characteristics unobtrusively without prompting, e.g., by noting its own location, or by silently taking weight and/or height measurements, or by silently photographing an individual and then extracting from the image a description of hair color, body shape, skin color, or some other physical characteristic, after which the image is discarded.

In some embodiments, a physical characteristic description 512 describes at least one of the following: gender, eye color, skin color, apparent race (e.g., observe and select from a list of choices), apparent ethnicity (similarly to race), age, age range (stated or observed), approximate age (within plus or minus 5 years), approximate height (within plus 5% to minus 5% of actual height), height range, height, approximate weight (within plus 10% to minus 10% of actual weight), weight range, weight, skin feature (e.g., a tattoo, birthmark, skin disease, mole, indicia printed on the skin, skin texture, pimples, hair or lack thereof, or another visually apparent aspect of skin), handedness, a voice recording, a badge physically linked to the individual, a missing digit, or another physical peculiarity. Other embodiments may use other physical aspects, which place the person in a group without specifically identifying them, provided they allow verification of personal authority without disclosing personal identifying information. One way to do this is to limit the verification basis to information that only places an individual in a group, of dozens or hundreds of people, for instance, without uniquely identifying the individual.

Characteristics 512 other than physical body traits may also be used, such as dates, times, general locations, and other characteristics not readily changeable by the person, or at least not routinely changed. Characteristics beyond the person's ready control, such as gender and height, are more reliable for verification than those more easily changed, such as hair color or the presence/absence of facial hair. Those using the system will understand this, and rely on or use verification procedures accordingly.

As a practical matter, even though more than one person may be named “John Smith” having a person's name makes it substantially easier to locate them, in a way that knowing their gender, approximate age, approximate weight, and hair color (for instance) does not. The invention takes advantage of such differences. That is, those of skill will acknowledge that there is a difference between (a) using information about a person to verify their claim in their presence or the memory of their presence, and (b) using information to locate or otherwise specifically identify them. If the displayed characteristic says “blond, six feet tall” but the person claiming that the confidential information pertains to them is red-haired and five-foot-six-inches tall, then their claim is not credible. Such conclusions can be reached without divulging a claimant's name, address, or other personal identifying information 114, so their privacy is protected even though their personal authority to claim the information (or their lack of authority) is verifiable.

During a description submitting step 304, the system user submits a group characteristic description 512 for storage in the electronic repository 510. This may be done using a mouse, microphone, keyboard, touch screen, camera, scale, or other familiar data entry device 508. The electronic repository may include one or more databases. The group characteristic description describes a characteristic of a person 502 which is shared other people, or which is at least perceived as being shared.

The electronic repository 510 is free of data fields 114 that identify the person 502. For instance, the repository may be required to exclude the person's name (full name in some embodiments, any portion of the name in others), telephone number, residential address, employer, credit card number, insurer-issued identification number, or government-issued identification number. In some cases even an email address is not stored, although in gneral confidential email is technologically possible, so that storing a pseudonymous email address need not always compromise a person's privacy. This absence of identifying information strongly distinguishes the repository 510 from most (perhaps all) databases maintained by government agencies, insurance companies, healthcare providers, employers, religious institutions, clubs, and educational institutions. Names, addresses, and other identifying information 116 routinely appear in those databases, and are routinely linked in those databases to confidential information 116.

During a confidence submitting step 306, the system user submits confidential information for retrievable storage in the electronic repository. This is submitted in connection with the group characteristic description, and may use similar devices as step 304, or others, such as a CD ROM drive, network connection, scanner, and so on. Although the submitted confidential information 116 pertains to a particular person, that person is not necessarily the system user. Information may also be submitted by an authorized tester or caregiver 506, for instance, by an attorney, by a family member or friend, and so on, including people 504 whom the person 502 has chosen to take into confidence, regardless of whether their identifying information is known to the person 502. Confidential information of the person 502 is submitted for later retrieval, without storing that person's identification in connection with their confidential information, and nonetheless facilitating verification that the confidential information pertains to that person.

In some embodiments, the confidential information 116 comprises at least one of the following: a result of a medical test performed on the individual, a medical treatment provided to the individual, at least a portion of a criminal history of the individual, at least a portion of a marital history of the individual, at least a portion of a credit history of the individual, an opinion stated by the individual, an opinion discussing the individual, a result of a background check on the individual, financial information of the individual, at least a portion of an employment history of the individual, at least a portion of a military service history of the individual, at least a portion of a religious history of the individual, at least a portion of a political activity history of the individual, at least a portion of a sexual history of the individual, at least a portion of a family history of the individual.

During a code receiving step 308, the system provides a code 522 for use in subsequently retrieving at least the submitted confidential information. Depending on the embodiment, the code may also be used to retrieve submitted characteristic description(s) 512. The code may be received in the form of a displayed number or alphanumeric sequence, a printed paper with a bar code or the like, a badge 526, or other format. Except for badges 526 that are physically attached to a person, codes 522 (like passwords) can be stolen, sold, or otherwise transferred, sometimes legitimately and sometimes not. Accordingly, the characteristic descriptions are used as discussed herein to reduce the risk that a person who presents a code and claims falsely on that basis to be the person to whom confidential information pertains, can be detected through a mismatch in recorded and present characteristics.

In some embodiments, the code incorporates characteristic descriptions, e.g., the third digit of a numeric code might specify race (1 for Native American, 2 for Hispanic, 3 for Black, etc.). Some or all of the descriptions 512 are thus stored within the code 522; another part of the code (e.g., digits 4 through 10) is an index into a set of confidential information 116 records. In some embodiments, the code includes an index into a database and the indexed record contains both the descriptions 512 and the confidential information. Other database implementations may also provide working embodiments of the invention. Some code digits in alphanumeric codes, for instance, may be used as checksums.

During a control specifying step 310, optional access controls 524 may be specified. For instance, a person 502 or someone acting on the person's behalf may specify a limit on the number of times the confidential information can be retrieved, confidential information deletion requirements, a requirement that a log be maintained showing the person a history of attempted retrievals of the confidential information including successful and unsuccessful attempts, and/or a requirement that the person 502 be notified (email, automated phone call, etc.) when an attempt is made to retrieve the confidential information.

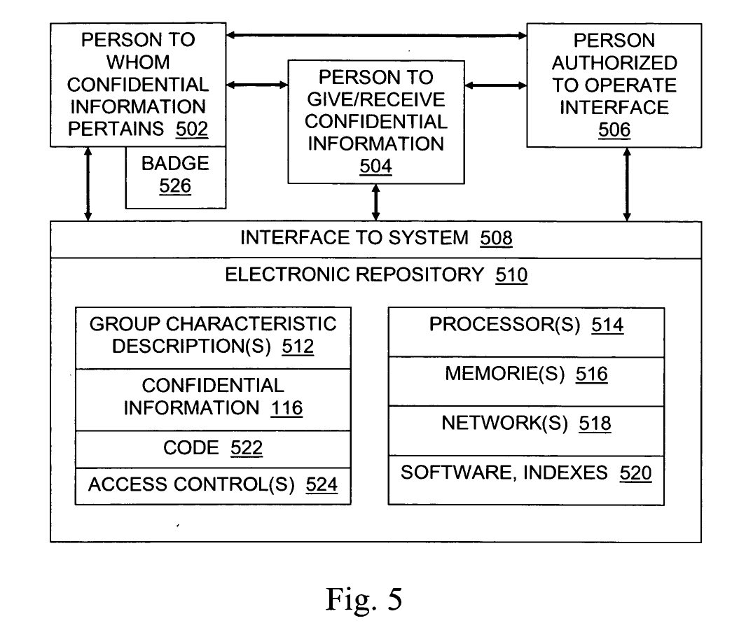

Any or all steps of the methods illustrated in FIGS. 3 and 4 can be reordered, repeated, omitted, supplemented, grouped differently, and/or named differently, except to the extent that doing so contradicts the claims or makes the method inoperative. By way of non-limiting examples, the code could be supplied 308 before the confidential information is submitted 306; multiple codes could be supplied for multiple submissions; and access controls might be unavailable (no step 310). Likewise, any or all system components illustrated in FIG. 5 can be located differently, repeated, omitted, supplemented, grouped differently, and/or named differently, except to the extent that doing so contradicts the claims or makes the system in question inoperative.

Note also that even though methods may be described from the system user's perspective or from the system's perspective, those of skill will apply knowledge of one perspective to the other perspective, and performing an action is often equivalent as a practical matter to causing the action to be performed. For instance, the distinction between receiving a code (user perspective) and giving the user a code (system perspective) is generally not critical to practicing the invention. One does not avoid infringement by merely asserting that it was the system, not oneself, which took some action necessary for infringement. The system is an actor or agent of the user, acting at the user's behest.

With particular attention now to FIG. 4, but continued reference to all Figures, the invention provides methods for retrieving confidential information. During a code entering step 402, a system user enters a code 522 into an interface 508 of an electronic repository 510 which contains confidential information 116 pertaining to a person 502. The user may be the person 502, or someone else, as noted elsewhere herein. The code may be entered using a keyboard, bar code scanner, magnetic card reader, RFID reader, camera, touch screen, mouse, and/or other input device 508. The electronic repository 510 is free of data fields that identify the person by name, telephone number, residential address, employer, credit card number, insurer-issued identification number, or government-issued identification number.

Then the user uses a verification procedure based on the group characteristic description and the code to at least help in verifying that a person to whom the confidential information may pertain is indeed the person to which it does pertain. This verification procedure may operate in at least two different ways, as shown by alternate paths in the flowchart of FIG. 4. One verification procedure goes through steps 404 and 406, while another verification procedure goes instead through step 414.

Under the leftmost path through steps 404 and 406, entry of the code causes the system 510 to retrieve characteristic descriptions 512 and to display 404 them. The associated confidential information 116 may 410 or may not 412 be also retrieved and/or displayed at this point, depending on the embodiment, for instance. The user compares 406 the displayed characteristics with those of the person claiming the confidential information as their own. If they match 408, then personal authority is deemed present (even without disclosure of the claiming person's identify information 114), and the associated confidential information 116 is treated as actually pertaining to the person who claimed it. If the displayed characteristics (the expected ones) do not match the characteristics of the person claiming the confidential information as their own, then that person's authority is questionable or missing, depending on the circumstances. For instance, if everything matches except hair color, personal authority may be deemed present if the person claiming the confidential information states that they've dyed their hair and that it used to be color X, and X is the expected color. If personal authority is deemed inadequate, then the confidential information is not disclosed 412; otherwise it is 410.

Thus, the electronic repository interface displays a group characteristic description in response to the entered code, and the leftmost verification procedure includes comparing the displayed group characteristic description with a group characteristic of the person to whom the confidential information may pertain.

Under the rightmost path through step 414, entry of the code causes the system 510 to prompt for characteristic descriptions 512. Then the system compares the submitted descriptions 512 with the previously stored expected descriptions 512 to see if they match 408. Thus, the user does not know what descriptions 512 were expected unless they also know something more about the person 502 than just their code. If the match is adequate or complete, then the confidential information is retrieved/disclosed 410; otherwise it is not 412.

Thus, the rightmost verification procedure includes entering at least one group characteristic description in connection with entering the code, and the confidential information is not retrieved if the entered group characteristic description fails to match a previously stored group characteristic description of the person to whom the confidential information pertains. In some cases, the previously stored group characteristic description is not displayed unless it was entered during this verification procedure.

With either procedure, the verification procedure group characteristic description can describe a randomly selected group characteristic, or a predictable one. For instance, an unpredictable selection might ask 304 for six characteristics and then later require entry 414 of three randomly selected from the six. Random selection by a system 510 includes mathematically random selections, quasi-random selections, and/or selections that are merely difficult for users to predict. Like other functionalities described herein, random selection functionality may be provided by software 520 which guides use of a computing system processor 514 and memories 516 in cooperation with an interface 508.

More about Systems of the Invention

With particular attention to FIG. 5, but reference to all Figures, the invention provides systems for managing confidential information. Some embodiments include the electronic repository 510 which contains confidential information 116 pertaining to a person. The system can be configured with an interface 508 and suitable software 520 for retrieval of the confidential information, by the person 502 and/or others, in response to entry 402 of a code 522. In some cases, entry 414 of matching 408 characteristic descriptions 512 is also required to retrieve 410 the confidential information 116.

The electronic repository may include one or more databases, but is free of data fields 114 that identify the person 502 whose confidential information it contains. This includes being free of correlations 206; merely storing the confidential information and the identifying information in different databases is not sufficient if those data can be linked through some correlation 206. Examples of identifying information include the person's name, telephone number, residential address, employer, credit card number, insurer-issued identification number, or government-issued identification number. In some embodiments, the electronic repository is free of the person's full name and of all other data fields that individually identify the person.

Unique identifiers such as fingerprints and DNA are likewise excluded as identifying information 114; they are used for identification by government agencies and others and hence appear in databases containing names, addresses, and the like. However, a set of characteristic descriptions 512 which collectively specify that the person present is indeed the person 502 to whom the confidential information pertains, may be used in some embodiments of the repository 510. Such description sets do not allow one to locate the person when they are not present, but do allow verification of their authority when they are present. For instance, some embodiments of the electronic repository contain one or more group characteristic descriptions, each of which by itself places the person 502 in a group of hundreds of people having a shared characteristic without specifically identifying the person.

To provide the functionality discussed herein, e.g., storing and retrieving confidential information, testing 408 for description matches, and controlling 310 access, systems use processors 514, memories 516 (RAM, nonvolatile), interface hardware, and other familiar computing system components, which are configured by software 520. For instance, an interface 508 to the electronic repository 510 utilizes software 520 to support verification procedure(s) based on the group characteristic description 512 and the code 522, as discussed in connection with FIG. 4. Suitable software 520 can be readily provided by those of skill in the pertinent art(s) using the teachings presented here and programming languages and tools such as C++, C, Java, Pascal, APIs, SDKs, SQL, SSL, HTTP, assembly, firmware, microcode, and/or other programming languages and tools. Suitable hardware for running the software can be special-purpose hardware and/or general purpose hardware that is configured by suitable software.

In some embodiments, the confidential information 116 is indexed 520 in the electronic repository based on at least a characteristic description and the code, and the code 522 alone is insufficient to retrieve the confidential information. This is presumed in many if not all implementations of the rightmost verification procedure of FIG. 4, for instance, but it may also be used in some implementations of the leftmost verification procedure. In some embodiments, the system stores a physical characteristic description 512 in the electronic repository such that the physical characteristic description is retrieved in connection with at least some of the confidential information, thereby allowing a comparison by a system user of the person 502's retrieved physical characteristic description with a physical characteristic description of a person 502/504 to whom the confidential information may pertain.

In some embodiments, the system receives multiple characteristic descriptions 512 of a person when confidential information of that person 502 is submitted to the electronic repository, and the system requires a randomly chosen proper subset of those characteristic descriptions to be entered 414 and match 408 before displaying 410 retrieved confidential information 116 of the person 502. As noted, the electronic repository may store in association with the confidential information one or more physical characteristic descriptions and/or other group characteristic descriptions 512 describing particular characteristics of the person 502 to whom the confidential information 116 pertains. The system allows retrieval of the confidential information of an individual without retrieving information specifically identifying the individual, although it may display information that merely places the individual among hundreds of people who have a particular characteristic.

In some embodiments, the system includes the code 522, and the code is physically linked to the person 502, e.g., by way of a badge 526. Several characteristics are desirable in a badge 526 according to the present invention. Depending on the embodiment and needs of the application, the badge should permit vigorous physical activity; should be easy to read at specified distance but visible only at the option of the person the badge pertains to; should be tamper-evident; should be non-reusable; should be cost-effective; should be difficult to counterfeit; and/or should be firmly attached or otherwise linked to the person whose information it displays. In connection with badges 526, as with other aspects of the present invention described herein, the term “should” merely denotes desirable characteristics, not characteristics (or features, steps, or structures) that are mandatory in every embodiment. The invention is defined by the claims.

The badge 526 is linked to the person whose information it bears. Suitable linkage may be performed by providing a current identification photo in the badge; by physically attaching the badge to the person using a bracelet, necklace, or anklet; by adhering a badge substrate to the person's skin; by surgically implanting a radiofrequency or similar encoded transponder in the person; by providing the same identifying code on the badge as on the person; and/or by printing the badge information on the person's skin, for example. Any means that reliably ties (a) the badge's informational indicia, to (b) the person those indicia describe, can be used. Printing on the person may be done in a manner similar to that done by amusement parks when they stamp “PAID” or a symbol on the back of one's hand. But in the present case the printing provides different information, e.g., confidential information access. Printing may comprise a bar code for enhanced badge security and quality control. “Fastening means” comprise items for fastening a badge's strap around someone to the badge or otherwise help attach the badge to a person. Examples include adhesives, chain, clips, knots, plastic or metal rivets, staples, string, tape, thread, and other fasteners. Other features, characteristics, materials, uses, supplementary items, alternatives, and aspects regarding or relating to badges are described in U.S. patent application Ser. No. 10/384,904 filed Mar. 27, 2003, incorporated herein.

Additional Comments

In the examples given herein, and other embodiments and/or other uses of the invention, persons A and B may know each other's personal identifying information through a source other than the inventive database, or they may not. In some cases A and B might be each other's spouse, for instance, while in some other cases they have met anonymously (e.g., through email or an Internet site) and never learn each other's personal identifying information even though they interact in person. To the extent the invention facilitates sexual activity, all of that activity presumably occurs legally between consenting adults. It is hoped that the invention will reduce transmission of disease and other unfortunate consequences of uninformed or rash behavior.

A system according to the invention, whether illustrated in FIG. 5 or otherwise, may include a means for providing anonymous test results, such as software configuring hardware to perform methods illustrated by FIG. 4 and/or other methods including those detailed below. An inventive system may include a means for managing anonymous medical information, such as software configuring hardware to perform methods illustrated by FIGS. 3 and 4 and/or other methods such as those detailed below.

One such method for providing anonymous medical test results to someone who has a personal health stake in those results includes the steps of: receiving a request that a medical test result from a medical test performed on a tested person 502 be provided 410 to a requester who has a personal health stake in those results, the request received by an entity other than the tested person; and providing a response for the requestor to receive through a computing device (e.g., cell phone, PDA, networked computer, wireless communication device such as a Blackberry device) that is distant from the request-receiving entity, the response including the medical test result 116 and also including an associated physical characteristic description 512 that describes a physical characteristic of the tested person; whereby the requestor is sent the medical test result from a reliable source which is not controlled by the tested person, the requestor is not sent information sufficient to locate the tested person within a general population, but the requestor is sent information which will allow the requestor to determine that a candidate person presenting to the requester as the purported tested person is not actually the tested person because a physical characteristic of the candidate does not match the provided physical characteristic description of the tested person.

In some cases, the response includes the result of at least one of the following medical tests: sexually transmitted disease test, test for a contagious disease which is not sexually transmitted, fertility test, genetic test.

The method may include authenticating the request before providing the response. For instance, when the request contains a checksum, the authenticating step 408 verifies the checksum or denies 412 the request.

In some cases, the physical characteristic description describes at least one of the following: gender, eye color, skin color, apparent race, apparent ethnicity, age range, approximate age (within plus or minus 5 years), age, approximate height (within plus 5% to minus 5% of actual height), height range, height, approximate weight (within plus 10% to minus 10% of actual weight), weight range, weight. The physical characteristic description may describe a badge linked to the tested person as described in pages 27-32 of published PCT patent application WO 2004/068315 (PCT/US2004/002415) (this entire published PCT application and the corresponding U.S. patent applications identified therein are each incorporated herein by reference). The physical characteristic description may describe a code 522 printed on the tested person's skin, by inking, tattooing, or other printing method, the showing numeric, alphanumeric, symbolic, and/or other visually perceptible content.

The providing step may read the medical test result from a database using at least part of the request as an index into the database. The providing step may read the medical test result from a database which contains no personal identifying information of the tested person. The providing step may read the medical test result from a database which contains no information permitting identification of a specific tested person, and also contains no information permitting correlation with another database to connect 208 a given test result to a specific identified tested person.

One such method for providing sex-related medical test results 116 to someone 502/504 who has a personal sexual interest in those results includes the steps of: authenticating a request that a sex-related medical test result from a sex-related medical test performed on a tested person be provided to a requestor; providing the requester, through a computing device, both the sex-related medical test result and an associated general identification 512 of the tested person 502; and preventing the requestor from receiving, through the computing device in association with the request, any specific identification of the tested person.

Authentication may include checksum tests 408 and/or verification procedures discussed above, for example. The authenticating step may receive authentication information over a network 518 and validate the authentication information at a computer other than the computing device through which the providing step provides the medical test result. Validating may include determining that no more than a previously specified number 524 of requests for the medical test result 116 have already been made before providing 410 the medical test results.

The providing step may provide the medical test result to a requester who has a personal sexual interest in those results by virtue of being a person with whom the tested person has been sexually active, or by virtue of being a person who is deciding whether to be sexually active with the tested person. The medical test result requester may also be the tested person. In some cases, the method provides a plurality of medical test results from a corresponding plurality of medical tests performed on the tested person, possibly on different dates.

In some cases, the method provides none of the following specific identification 114 of the tested person: full name, employer name, full residential address, full employer address, full personal telephone number, full employer telephone number, government-issued identification number, insurer-issued identification number. The providing step may provide 404 the date 512 on which the medical test occurred, and may also provide the general location 512 at which the medical test was performed.

One such method for providing sex-related medical test results to someone who has a personal sexual interest in those results includes the steps of: authenticating a request that a sex-related medical test result from a sex-related medical test performed on a tested person be provided to a requestor; accessing a sex-related medical test result from a database 510 of which lacks corresponding specific identification of the tested person; and providing the requestor, through a computing device, the sex-related medical test result and an associated general identification of the tested person.

One such method for obtaining medical test results includes the steps of: making an authentic request that medical test results be provided; and obtaining through a computing device both a medical test result 116 from a medical test performed on a tested person, and an associated general identification 512 of the tested person, without obtaining solely from the computing device a specific identification of the tested person. In some cases, the method further includes reading a code 522 which is physically linked to the tested person, as by a badge 526, for instance, or by being printed on the person, and making an authentic request includes entering 402 the code in the computing device. The step of making an authentic request may include entering 414 a testing date, a testing general location, and a code into the computing device 508, and the obtaining step includes obtaining a result of a medical test that was performed on the tested person on the testing date at the testing general location.

Such methods may include setting 310 a limit on instances in which the medical test results can be obtained in the future, and/or displaying 310 a log of instances in which the medical test results have been previously obtained.

Such methods may include comparing 408 the general identification of the tested person with at least one characteristic of a candidate person to determine if the candidate person cannot be the tested person because the candidate's characteristic does not match the tested person's general identification.

One such method of updating a medical test result database includes the steps of: gaining authorized access to the database as a medical service provider 506 having a medical service facility; and entering into the database through a computing device both a medical test result 116 from a medical test performed on a tested person 502 at the medical service facility, and an associated general identification 512 of the tested person, without entering a specific identification 114 of the tested person. The general identification may include a description of at least one physical characteristic of the tested person, and the choice of characteristic(s) to describe may be made 302 randomly during the entering step.

Similar methods to the above may be used to store, retrieve, share, and otherwise manage other types of confidential information 1116, in addition to managing confidential medical information.

### CONCLUSION

The present invention is described by the appended claims, and by this specification overall; the claims are a part of the specification, and repeated claim language may be inserted outside the claims as needed. The examples given are illustrative but not necessarily limiting. Although particular embodiments of the present invention are expressly illustrated and described individually herein, it will be appreciated that discussion of one type of embodiment also generally extends to other embodiment types. For instance, the description of the methods illustrated in FIGS. 3 and 4 also helps describe the systems in FIG. 5, and vice versa.

As used herein, terms such as “a” and “the” and designations such as “retrieving”, and “database”, are inclusive of one or more of the indicated item or step. In particular, in the claims a reference to an item generally means at least one such item is present and a reference to a step means at least one instance of the step is performed.

The invention may be embodied in other specific forms without departing from its essential characteristics. Headings are for convenience only. The scope of the invention is, therefore, indicated by the appended claims rather than by the foregoing description. All changes which come within the meaning and range of equivalency of the claims are to be embraced within their scope to the full extent permitted by law.

What is claimed and desired to be secured by patent is:

1. A method for submitting confidential information, comprising the steps of:
submitting a group characteristic description for storage in an electronic repository, the group characteristic description describing a characteristic of a person which is shared by at least a dozen other people, the electronic repository being free of data fields that identify the person by name, telephone number, residential address, employer, credit card number, insurer-issued identification number, or government-issued identification number; and
submitting confidential information for retrievable storage in the electronic repository in connection with the group characteristic description, the confidential information pertaining to the person;
thereby submitting for later retrieval the confidential information of the person, without storing the person's identification in connection with their confidential information, and nonetheless facilitating verification that the confidential information pertains to the person.

2. The method of claim 1, wherein the submitted group characteristic description comprises a physical characteristic description which describes a physical characteristic of the person.

3. The method of claim 1, wherein the submitted confidential information comprises medical information pertaining to the person.

4. The method of claim 1, further comprising receiving a code for use in subsequently retrieving at least the submitted confidential information.

5. The method of claim 1, further comprising specifying at least one of the following as an access control: a limit on the number of times the confidential information can be retrieved, a requirement that a log be maintained showing the person a history of attempted retrievals of the confidential information including successful and unsuccessful attempts, a requirement that the person be notified when an attempt is made to retrieve the confidential information, a requirement that the record be deleted after it is accessed a certain number of time(s).

6. A method for retrieving confidential information, comprising the steps of:
entering a code into an interface of an electronic repository which contains confidential information pertaining to a person, the electronic repository being free of data fields that identify the person by name, telephone number, residential address, employer, credit card number, insurer-issued identification number, or government-issued identification number; and
using a verification procedure based on the group characteristic description and the code to at least help in verifying that a person to whom the confidential information may pertain is indeed the person to which it does pertain.

7. The method of claim 6, wherein the electronic repository interface displays a group characteristic description in response to the entered code, and the verification procedure comprises comparing the displayed group characteristic description with a group characteristic of the person to whom the confidential information may pertain.

8. The method of claim 6, wherein the verification procedure comprises entering at least one group characteristic description in connection with entering the code, and the confidential information is not retrieved if the entered group characteristic description fails to match a previously stored group characteristic description of the person to whom the confidential information pertains.

9. The method of claim 8, wherein the previously stored group characteristic description is not displayed unless it was entered during the verification procedure.

10. The method of claim 6, wherein the verification procedure group characteristic description describes a randomly selected group characteristic.

11. The method of claim 6, wherein the code entering step is performed by the person to whom the confidential information pertains.

12. A system for managing confidential information, comprising:
an electronic repository which contains confidential information pertaining to a person and is configured for retrieval of the confidential information by the person in response to at least entry of a code, the electronic repository being free of data fields that effectively identify the person by name, telephone number, residential address, employer, credit card number, insurer-issued identification number, or government-issued identification number, the electronic repository also containing a group characteristic description which places the person in a group of hundreds of people having a shared characteristic without specifically identifying the person; and
a processor and a memory configured to provide an interface to the electronic repository supporting a verification procedure based on the group characteristic description and the code.

13. The system of claim 12, wherein the confidential information is indexed in the electronic repository based on at least a physical characteristic description and the code, and the code alone is insufficient to retrieve the confidential information.

14. The system of claim 12, wherein the electronic repository stores in association with the confidential information a plurality of group characteristic descriptions describing particular characteristics of the person to whom the confidential information pertains.

15. The system of claim 12, wherein the system comprises a means for providing anonymous test results.

16. The system of claim 12, wherein the system further comprises the code, and the code is physically linked to the person.

17. The system of claim 12, wherein the system receives multiple physical characteristic descriptions of a person when confidential information of that person is submitted to the electronic repository, and the system requires a randomly chosen proper subset of those characteristic descriptions to be entered and match before displaying retrieved confidential information of the person.

18. The system of claim 12, wherein the system stores a physical characteristic description in the electronic repository such that the physical characteristic description can be retrieved in connection with at least some of the confidential information, thereby allowing a comparison by a system user of the person's retrieved physical characteristic description with a physical characteristic description of a person to whom the confidential information may pertain.

19. The system of claim 12, wherein the electronic repository is free of the person's full name and of all other data fields that individually identify the person.

20. The system of claim 12, wherein the system comprises a means for managing anonymous medical information.
